(19) United States
(12) Patent Application Publication
(10) Pub. No.: US 2022/0359916 A1
(43) Pub. Date: Nov. 10, 2022

(54) SECONDARY BATTERY, ELECTRONIC DEVICE, AND ELECTRIC TOOL

(71) Applicant: MURATA MANUFACTURING CO., LTD., Kyoto (JP)

(72) Inventor: Takatoshi KONDO, Kyoto (JP)

(21) Appl. No.: 17/868,351

(22) Filed: Jul. 19, 2022

Related U.S. Application Data
(63) Continuation of application No. PCT/JP2021/000826, filed on Jan. 13, 2021.

(30) Foreign Application Priority Data
Jan. 23, 2020 (JP) 2020-009166

(51) Int. Cl. H01M 10/0587; H01M 10/0525

(52) U.S. Cl. CPC H01M 10/0587; H01M 10/0525; H01M 2220/30

(57) ABSTRACT

Provided is a secondary battery, where a positive electrode includes a covered part covered with a positive electrode active material layer and a positive electrode active material non-covered part on a band-shaped positive electrode foil, and a negative electrode includes a covered part covered with a negative electrode active material layer and a negative electrode active material non-covered part on a band-shaped negative electrode foil, the positive electrode active material non-covered part is joined to the positive electrode current-collecting plate at one end of an electrode wound body, and the negative electrode active material non-covered part is joined to the negative electrode current-collecting plate at the other end of the electrode wound body, any one or both of the positive electrode active material non-covered part and the negative electrode active material non-covered part have a flat surface formed by bending toward a central axis of the wound structure and overlapping.

### CROSS REFERENCE TO RELATED APPLICATIONS

The present application is a continuation of PCT patent application No. PCT/JP2021/000826, filed Jan. 13, 2021, which claims priority to Japanese patent application no. JP 2020-009166, filed Jan. 23, 2020, the entire contents of which are being incorporated herein by reference.

### BACKGROUND

The present application relates to a secondary battery, an electronic device, and an electric tool.

Lithium ion batteries have been developed for applications that require high power, such as electric tools and automobiles. Methods for achieving high power include a method of high-rate discharge for the flow of a relatively large current from a battery. The high-rate discharge has a problem with the internal resistance of the battery, because of the flow of the large current.

For example, a battery is described having a high current-collecting efficiency, for which a positive electrode and a negative electrode are wound while the position where the positive electrode and the negative electrode have an overlap with each other is shifted in the width direction, an end is bent to prepare a flat surface, and a current-collecting plate is joined to the flat surface by laser welding.

### SUMMARY

The present application relates to a secondary battery, an electronic device, and an electric tool.

As noted above in BACKGROUND section, a battery is described having a high current-collecting efficiency, in which a current-collecting plate is joined by laser welding to a current collector protruded to one side of an electrode plate group obtained by winding a positive electrode plate and a negative electrode plate stacked with a separator interposed therebetween. However, because of the laser welding in the radial direction, the joints between the electrode plate group and the current-collecting plate, that is, the intervals between welded points are not uniform. In particular, because the interval between the welded points is long at the outer periphery of the electrode plate group, the battery has the problem of being high in internal resistance.

In addition, the current-collecting plate is joined to the flat part obtained by pressing an end of the electrode plate group in the winding axis direction. However, in the case of pressing by such a method, wrinkles and voids (voids and spaces) are inevitably generated at the flat part. When wrinkles or voids are present, defects in welding to the current-collecting plate may be caused in some cases.

Accordingly, the present technology relates to providing a battery where the internal resistance has a low value, and a current-collecting plate and a flat surface of an end can be welded stably according to an embodiment.

For solving the problems described above, the present application, in an embodiment, provides a secondary battery including: an electrode wound body that has a band-shaped positive electrode and a band-shaped negative electrode stacked with a separator interposed therebetween and has a wound structure; a positive electrode current-collecting plate; a negative electrode current-collecting plate; and a battery can housing the electrode wound body, the positive electrode current-collecting plate and the negative electrode current-collecting plate,

in which the positive electrode includes a covered part covered with a positive electrode active material layer and a positive electrode active material non-covered part on a band-shaped positive electrode foil,

the negative electrode includes a covered part covered with a negative electrode active material layer and a negative electrode active material non-covered part on a band-shaped negative electrode foil,

the positive electrode active material non-covered part is joined to the positive electrode current-collecting plate at one end of the electrode wound body,

the negative electrode active material non-covered part is joined to the negative electrode current-collecting plate at the other end of the electrode wound body,

any one or both of the positive electrode active material non-covered part and the negative electrode active material non-covered part have a flat surface formed by bending toward a central axis of the wound structure and overlapping each other, and

a groove formed in the flat surface,

a position of the positive electrode current-collecting plate or a position of the negative electrode current-collecting plate corresponding to a position of the flat surface without any groove has a welded point group, and

the welded point group has a concentric or spiral shape.

According to an embodiment of the present application, the current-collecting plate and the flat surface of the end can be reliably welded, the internal resistance of the battery can be reduced, or a high-power battery can be achieved. It is to be noted that the contents of the present application are not to be construed as being limited by the effects illustrated in this specification.

### BRIEF DESCRIPTION OF THE FIGURES

FIG. 1 is a sectional view of a battery according to an embodiment.

FIG. 2 is a diagram illustrating an example of a relationship among a positive electrode, a negative electrode, and a separator disposed in an electrode wound body.

FIG. 3 includes views A and B, where A is a plan view of a positive electrode current-collecting plate, and where B is a plan view of a negative electrode current-collecting plate.

FIG. 4 includes views A to F which are diagrams illustrating a process for assembling a battery.

FIG. 5 includes views A and B which are diagrams illustrating Examples 1, 3, 5, and 7.

FIG. 6 includes views A and B which are diagrams illustrating Examples 2, 4, 6, and 8.

FIG. 7 includes views A and B which are diagrams illustrating Comparative Example 1.

FIG. 8 includes views A and B which are diagrams illustrating Comparative Example 2.

FIG. 9 includes views A and B which are diagrams illustrating Comparative Example 3.

FIG. 10 is a connection diagram for use in description of a battery pack as an application example according to an embodiment.

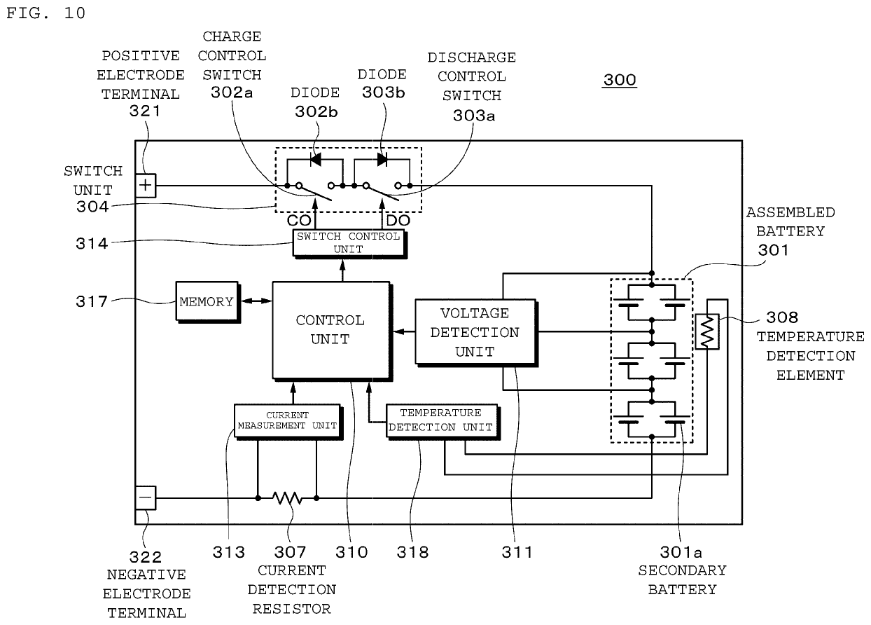

FIG. 11 is a connection diagram for use in description of an electric tool as an application example according to an embodiment.

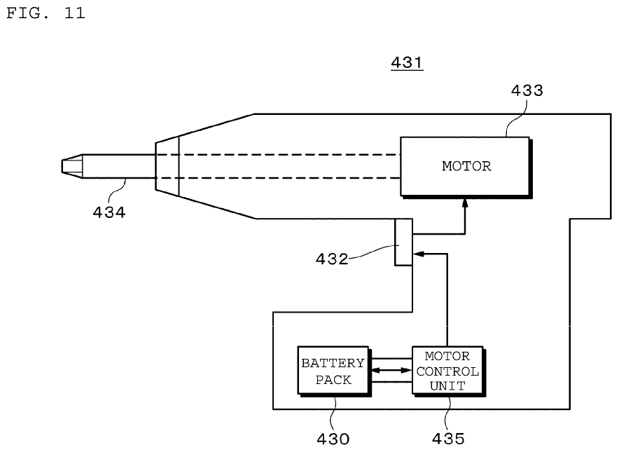

FIG. 12 is a connection diagram for use in description of an electric vehicle as an application example according to an embodiment.

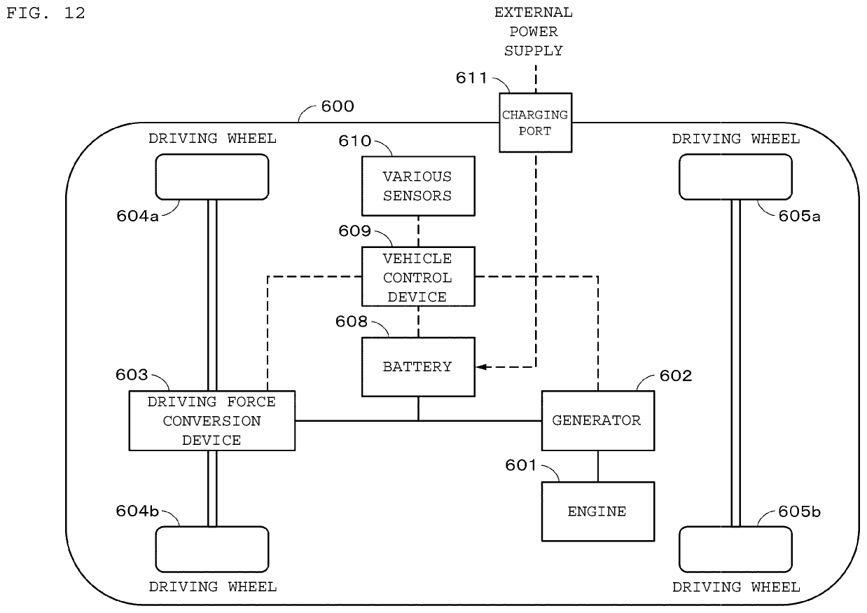

### DETAILED DESCRIPTION

Hereinafter, the present application will be described in further detail including with reference to the drawings according to an embodiment. The present application is described below with reference to preferred specific examples, and without limitation, according to an embodiment.

In an embodiment, a cylindrical lithium ion battery will be described as an example of the secondary battery.

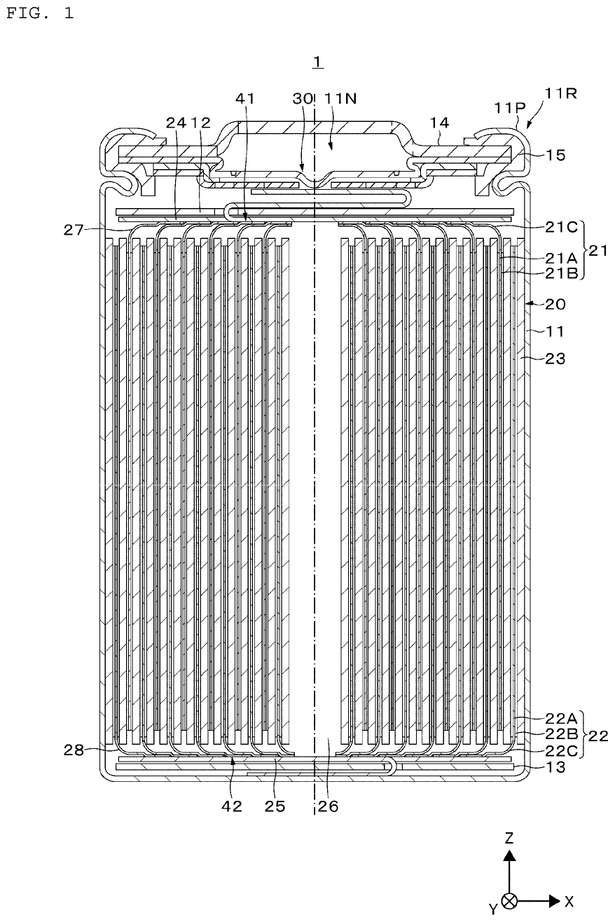

First, the overall configuration of the lithium ion battery will be described. FIG. 1 is a schematic sectional view of a lithium ion battery 1. The lithium ion battery 1 is, for example, a cylindrical lithium ion battery 1 that has an electrode wound body 20 is housed inside a battery can 11 as shown in FIG. 1.

Specifically, the lithium ion battery 1 includes, for example, a pair of insulating plates 12 and 13 and an electrode wound body 20 inside the cylindrical battery can 11. The lithium ion battery 1 may further, however, include, for example, any one of, or two or more of a positive temperature coefficient (PTC) element, a reinforcing member, and the like inside the battery can 11.

The battery can 11 is a member that mainly houses the electrode wound body 20. The exterior can 11 is, for example, a cylindrical container with one end surface thereof opened and the other end surface thereof closed. More specifically, the exterior can 11 has an opened end surface (open end surface 11N). The battery can 11 contains, for example, any one of, or two or more of metal materials such as iron, aluminum, and alloys thereof. The surface of the battery can 11 may be, however, plated with, for example, any one of, or two or more of metal materials such as nickel.

The insulating plates 12 and 13 are dish-shaped plates that each have a surface substantially perpendicular to the winding axis (Z axis in FIG. 1) of the electrode wound body 20. In addition, the insulating plates 12 and 13 are disposed so as to sandwich the electrode wound body 20 therebetween, for example.

At the open end surface 11N of the battery can 11, the battery cover 14 and the safety valve mechanism 30 are crimped with the gasket 15 to form a crimped structure 11R (crimped structure). Thus, with the electrode wound body 20 and the like housed inside the battery can 11, the battery can 11 is sealed.

The battery cover 14 is a member that closes the open end surface 11N of the battery can 11 mainly with the electrode wound body 20 and the like housed inside the battery can 11. The battery cover 14 contains, for example, the same material as the material that forms the battery can 11. The central region of the battery cover 14 protrudes in the +Z direction, for example. Thus, the region (peripheral region) of the battery cover 14 other than the central region has contact with, for example, the safety valve mechanism 30.

The gasket 15 is a member mainly interposed between the battery can 11 (bent part 11P) and the battery cover 14 to seal the gap between the bent part 11P and the battery cover 14. For example, asphalt or the like may be, however, applied to the surface of the gasket 15.

The gasket 15 contains, for example, any one of, or two or more of insulating materials. The types of the insulating materials are not particularly limited, and may be, for example, a polymer material such as a polybutylene terephthalate (PBT) and a polypropylene (PP). In particular, the insulating material is preferably a polybutylene terephthalate. This is because the gap between the bent part 11P and the battery cover 14 is sufficiently sealed while the battery can 11 and the battery cover 14 are electrically separated from each other.

The safety valve mechanism 30 mainly releases the sealed state of the battery can 11 to release the pressure (internal pressure) inside the battery can 11, if necessary, when the internal pressure is increased. The cause of the increase in the internal pressure of the battery can 11 is, for example, a gas generated due to a decomposition reaction of an electrolytic solution during charging or discharging.

For the cylindrical lithium ion battery, a band-shaped positive electrode 21 and a band-shaped negative electrode 22 are spirally wound with a separator 23 interposed therebetween, impregnated with an electrolytic solution, and housed in the battery can 11. The positive electrode 21 is obtained by forming a positive electrode active material layer 21B on one or both surfaces of a positive electrode foil 21A, and the material of the positive electrode foil 21A is, for example, a metal foil made of aluminum or an aluminum alloy. The negative electrode 22 is obtained by forming a negative electrode active material layer 22B on one or both surfaces of a negative electrode foil 22A, and the material of the negative electrode foil 22A is, for example, a metal foil made of nickel, a nickel alloy, copper, or a copper alloy. The separator 23 is a porous and insulating film, which enables transfer of substances such as ions and an electrolytic solution while electrically insulating the positive electrode 21 and the negative electrode 22.

The positive electrode active material layer 21B and the negative electrode active material layer 22B respectively cover most of the positive electrode foil 21A and the negative electrode foil 22A, but intentionally, neither of the layers covers one end periphery in the short axis direction of the band. Hereinafter, the part covered with no active material layer 21B or 22B is appropriately referred to as an active material non-covered part, whereas the part covered with the active material layer 21B or 22B is appropriately referred to as an active material covered part. In the cylindrical battery, the electrode wound body 20 is wound in such a manner that an active material non-covered part 21C of the positive electrode and an active material non-covered part 22C of the negative electrode are overlapped with each other with the separator 23 interposed therebetween so as to face in opposite directions.

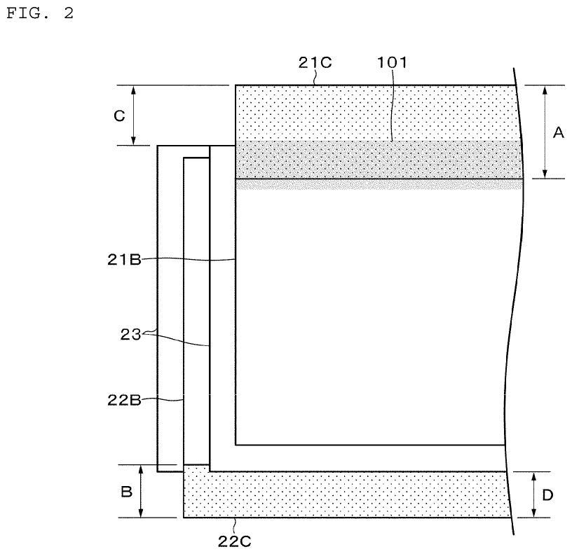

FIG. 2 shows an example of a structure with the positive electrode 21, the negative electrode 22, and the separator 23 stacked before winding. The active material non-covered part 21C (the upper dotted part in FIG. 2) of the positive electrode has a width denoted by A, and the active material non-covered part 22C (the lower dotted part in FIG. 2) of the negative electrode has a width denoted by B. According to one embodiment, A>B is preferred, for example, A=7 (mm) and B=4 (mm). A part of the active material non-covered part 21C of the positive electrode, protruded from one end of the separator 23 in the width direction, has a length denoted by C, and a part of the active material non-covered part 22C of the negative electrode, protruded from the other end of the separator 23 in the width direction, has a length denoted by D. According to one embodiment, C>D is preferred, for example, C=4.5 (mm) and D=3 (mm).

The active material non-covered part 21C of the positive electrode is made of, for example, aluminum, whereas the active material non-covered part 22C of the negative electrode is made of, for example, copper, and thus, the active material non-covered part 21C of the positive electrode is typically softer (has a lower Young's modulus) than the active material non-covered part 22C of the negative electrode. Thus, according to one embodiment, A>B and C>D are more preferred, and in this case, when the active material non-covered part 21C of the positive electrode and the active material non-covered part 22C of the negative electrode are bent at the same pressure simultaneously from both electrode sides, the positive electrode 21 and the negative electrode 22 may be similar in the height of the bent part, measured from the tip of the separator 23. In this case, the active material non-covered parts 21C and 22C are bent to appropriately overlap with each other, thus allowing the active material non-covered parts 21C and 22C and current-collecting plates 24 and 25 to be easily joined by laser welding. Joining according to one embodiment means joining by laser welding, but the joining method is not limited to laser welding.

A part of the active material non-covered part 21C of the positive electrode that faces the negative electrode 22 with the separator 23 interposed therebetween is covered with an insulating layer 101 (gray part in FIG. 2) over a section of 3 mm in length from the tip of the positive electrode active material layer 21B, for example. The lithium ion battery 1 is, as shown in FIG. 2, designed such that the width of the positive electrode active material layer 21B is shorter than the width of the negative electrode active material layer 22B. Accordingly, in the case where the insulating layer 101 is not present, there is a possibility that Li metal or the like will be deposited on a part of the active material non-covered part 21C of the positive electrode that faces the negative electrode active material layer 22B during charging and discharging, or when an impact is applied to the battery 1, there is a possibility that the impact will not be absorbed at all, thereby bending the active material non-covered part 21C of the positive electrode, causing the bent part to come into contact with the negative electrode 22, and resulting in a short circuit. The insulating layer 101 is disposed for avoiding these possibilities.

The central axis of the electrode wound body 20 has a through hole 26 formed. The through hole 26 is a hole for insertion of a winding core for assembling the electrode wound body 20 and an electrode rod for welding. The electrode wound body 20 is wound in an overlapping manner such that the active material non-covered part 21C of the positive electrode and the active material non-covered part 22C of the negative electrode face in the opposite directions, and thus, the active material non-covered part 21C of the positive electrode is gathered at one (end surface 41) of the end surfaces of the electrode wound body, whereas the active material non-covered part 22C of the negative electrode is gathered at the other (end surface 42) of the end surfaces of the electrode wound body 20. For improving contact with the current-collecting plates 24 and 25 for current extraction, the active material non-covered parts 21C and 22C are bent, and the end surfaces 41 and 42 have flat surfaces. The bending directions are directions from the outer edges 27 and 28 of the end surface s 41 and 42 toward the through hole 26, and peripheral active material non-covered parts that are adjacent in the wound state are bent in a manner of overlapping with each other. In this specification, the “flat surface” includes not only a perfectly flat surface but also a surface with some unevenness and surface roughness to the extent that the active material non-covered part and the current-collecting plate can be joined.

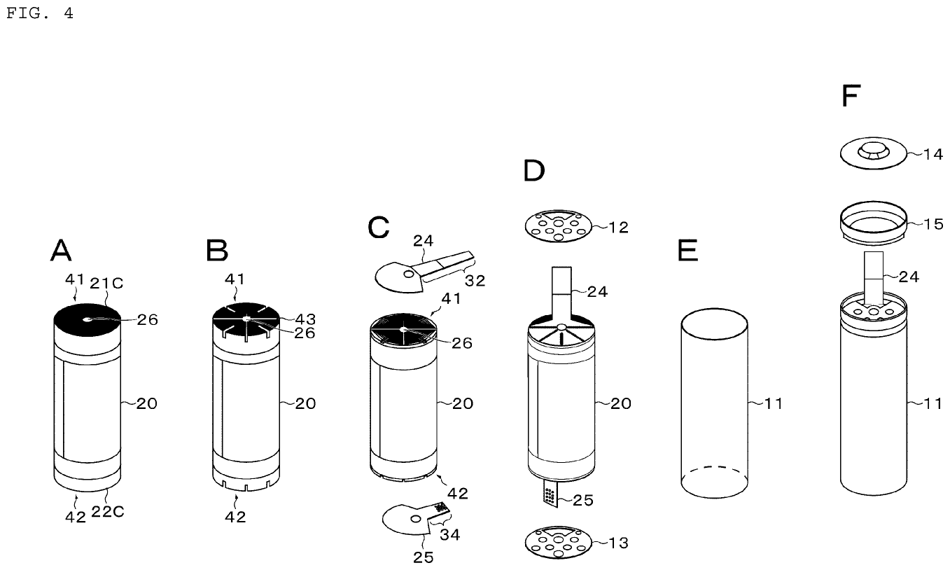

When each of the active material non-covered parts 21C and 22C are bent so as to have an overlap, it seems possible for the end surfaces 41 and 42 to have flat surfaces, but if no processing is performed before bending, wrinkles or voids (voids, spaces) are generated at the end surfaces 41 and 42 at the time of bending, and the end surfaces 41 and 42 have no flat surfaces. In this regard, the “wrinkles” or “voids” are portions where the bent active material non-covered parts 21C and 22C are biased, thereby causing the end surfaces 41 and 42 to have no flat surfaces. For preventing the generation of wrinkles and voids, grooves 43 (see, for example, FIG. 4B) are formed in advance in radiation directions from the through hole 26. The groove 43 extends from the outer edges 27 and 28 of the end surfaces 41 and 42 to the through hole 26. The center of the electrode wound body 20 has the through hole 26, and the through hole 26 is used as a hole into which a welding tool is inserted in the process of assembling the lithium ion battery 1. The active material non-covered parts 21C and 22C have notches at the start of winding the positive electrode 21 and the negative electrode 22 near the through hole 26. This is for keeping the through hole 26 from being closed in the case of bending toward the through hole 26. The grooves 43 remain in the flat surfaces also after bending the active material non-covered parts 21C and 22C, and parts without the grooves 43 are joined (welded or the like) to the positive electrode current-collecting plate 24 or the negative electrode current-collecting plate 25. It is to be noted that the grooves 43 as well as the flat surfaces may be joined to a part of the current-collecting plates 24 and 25.

The detailed configuration of the electrode wound body 20, that is, the respective detailed configuration of the positive electrode 21, negative electrode 22, separator 23, and electrolytic solution will be described later.

In a common lithium ion battery, for example, a lead for current extraction is welded to each one of the positive electrode and negative electrode, but this is not suitable for high-rate discharge because of the high internal resistance of the battery and the temperature increased by heat generation of the lithium ion battery in the case of discharging. Thus, in the lithium ion battery according to one embodiment, the internal resistance of the battery is kept low by disposing the positive electrode current-collecting plate 24 and the negative electrode current-collecting plate 25 at the end surfaces 41 and 42, and welding at multiple points to the active material non-covered parts 21C and 22C of the positive electrode and negative electrode present at the end surfaces 41 and 42. The end surfaces 41 and 42 are bent to form flat surfaces, which also contributes to the reduction in resistance.

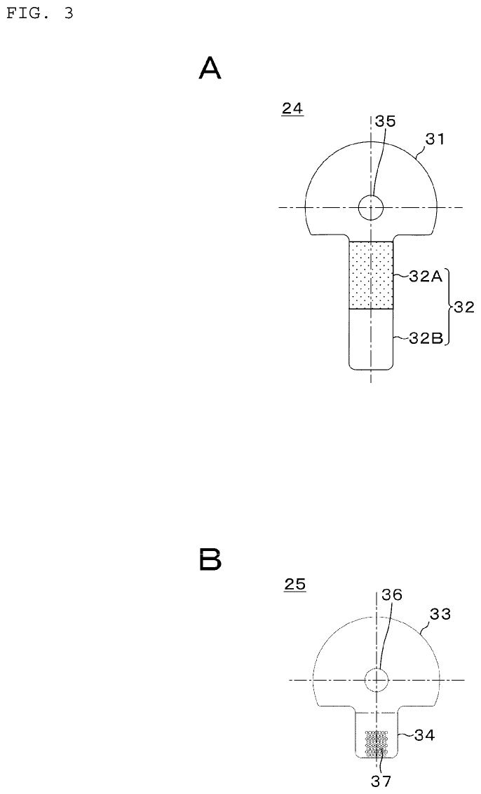

FIG. 3A and FIG. 3B show examples of the current-collecting plates. FIG. 3A shows the positive electrode current-collecting plate 24, and FIG. 3B shows the negative electrode current-collecting plate 25. The material of the positive electrode current-collecting plate 24 is, for example, a metal plate made of a simple substance of aluminum or an aluminum alloy or a composite thereof, and the material of the negative electrode current-collecting plate 25 is, for example, a metal plate made of a simple substance of nickel, a nickel alloy, copper, or a copper alloy or a composite thereof. As shown in FIG. 3A, the positive electrode current-collecting plate 24 has the shape of a flat fan-shaped part 31 with a rectangular band-shaped part 32 attached thereto. The fan-shaped part 31 has, near the center thereof, a hole 35 formed, and the hole 35 is located at a position corresponding to the through hole 26.

A dotted part in FIG. 3A is an insulating part 32A where an insulating tape is attached to the band-shaped part 32 or an insulating material is applied thereto, and the part below the dotted part in the drawing is a connecting part 32B to a sealing plate that also serves as an external terminal. It is to be noted that in the case of a battery structure without any metallic center pin (not shown) in the through hole 26, the band-shaped part 32 has a low probability of coming into contact with a site with a negative electrode potential, and thus, there is no need for the insulating part 32A. In such a case, the widths of the positive electrode 21 and negative electrode 22 can be increased by an amount corresponding to the thickness of the insulating part 32A to increase the charge/discharge capacity.

The negative electrode current-collecting plate 25 has substantially the same shape as the positive electrode current-collecting plate 24, but has a different band-shaped part. The band-shaped part 34 of the negative electrode current-collecting plate in FIG. 3B is shorter than the band-shaped part 32 of the positive electrode current-collecting plate, without any part corresponding to the insulating part 32A. The band-shaped part 34 has a round protrusion (projection) 37 indicated by a plurality of circles. During resistance welding, current is concentrated on the protrusion, and the protrusion is melted to weld the band-shaped part 34 to the bottom of the battery can 11. Similarly to the positive electrode current-collecting plate 24, the negative electrode current-collecting plate 25 has a hole 36 near the center of a fan-shaped part 33, and the hole 36 is located at a position corresponding to the through hole 26. The fan-shaped part 31 of the positive electrode current-collecting plate 24 and the fan-shaped part 33 of the negative electrode current-collecting plate 25 have a fan shape, and thus cover a part of the end surfaces 41 and 42. The reason that the whole is not covered to allow an electrolytic solution to smoothly permeate the electrode wound body in the assembly of the battery, or to make it easier for the gas generated when the battery reaches an abnormally high-temperature state or overcharge state to be released to the outside of the battery.

The positive electrode active material layer includes at least a positive electrode material (positive electrode active material) capable of occluding and releasing lithium, and may further include a positive electrode binder, a positive electrode conductive agent, and the like. The positive electrode material is preferably a lithium-containing composite oxide or a lithium-containing phosphate compound. The lithium-containing composite oxide has, for example, a layered rock salt-type or spinel-type crystal structure. The lithium-containing phosphate compound has, for example, an olivine type.

The positive electrode binder includes a synthetic rubber or a polymer compounds. The synthetic rubbers may be styrene-butadiene rubbers, fluorine rubbers, ethylene propylene diene, and the like. Examples of the polymer compounds include a polyvinylidene fluoride (PVdF) and a polyimide.

The positive electrode conductive agent may be a carbon material such as graphite, carbon black, acetylene black, or Ketjen black. The positive electrode conductive agent may be, however, a metal material and a conductive polymer.

The surface of the negative electrode current collector is preferably roughened for improving the adhesion to the negative electrode active material layer. The negative electrode active material layer includes at least a negative electrode material (negative electrode active material) capable of occluding and releasing lithium, and may further include a negative electrode binder, a negative electrode conductive agent, and the like.

The negative electrode material incudes, for example, a carbon material. The carbon materials may be, for example, graphitizable carbon, non-graphitizable carbon, graphite, low-crystallinity carbon, or amorphous carbon. The shape of the carbon has a fibrous, spherical, granular, or scaly shape.

The negative electrode material includes, for example, a metal-based material. Examples of the metal-based material include Li (lithium), Si (silicon), Sn (tin), Al (aluminum), Zr (zinc), and Ti (titanium). The metal-based element forms a compound, a mixture, or an alloy with another element, and examples thereof include a silicon oxide (SiOₓ (0<x≤2)), a silicon carbide (SiC) or an alloy of carbon and silicon, and a lithium titanate (LTO).

The separator 23 is a porous membrane containing a resin, and may be a laminated film of two or more porous films. The resin may be a polypropylene and a polyethylene. The separator 23 may include a resin layer on one or both surfaces of the porous membrane as a substrate layer. This is because the adhesion of the separator 23 to each of the positive electrode 21 and the negative electrode 22 is improved, thus keeping the electrode wound body 20 from warping.

The resin layer contains a resin such as PVdF. In the case of forming the resin layer, a solution in which a resin is dissolved in an organic solvent or the like is applied to the substrate layer, and then the substrate layer is dried. It is to be noted that after immersing the substrate layer in the solution, the base material layer may be dried. The resin layer preferably includes inorganic particles or organic particles from the viewpoint of improving the heat resistance and the safety of the battery. The type of the inorganic particles is an aluminum oxide, an aluminum nitride, an aluminum hydroxide, a magnesium hydroxide, boehmite, talc, silica, mica, or the like. In place of the resin layer, a surface layer containing inorganic particles as a main component may be used, which is formed by a sputtering method, an atomic layer deposition (ALD) method, or the like.

The electrolytic solution includes a solvent and an electrolyte salt, and may further include an additive and the like, if necessary. The solvent is a nonaqueous solvent such as an organic solvent, or water. The electrolytic solution including a nonaqueous solvent is referred to as a nonaqueous electrolytic solution. The nonaqueous solvent may be a cyclic carbonate, a chain carbonate, a lactone, a chain carboxylate, a nitrile (mononitrile), or the like.

Typical examples of the electrolyte salt are lithium salts, but a salt other than lithium salts may be contained. The lithium salt may be lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), dilithium hexafluorosilicate (Li₂SF₆), and the like. These salts can also be used in mixture, above all, the use of LiPF₆ and LiBF₄ in mixture is preferred from the viewpoint of improving battery characteristics. The content of the electrolyte salt is not particularly limited, but preferably 0.3 mol/kg to 3 mol/kg with respect to the solvent.

A method for manufacturing the lithium ion battery 1 according to one embodiment will be described with reference to FIG. 4A to FIG. 4F. First, a positive electrode active material was applied to the surface of the band-shaped positive electrode foil 21A to form a covered part for the positive electrode 21, and a negative electrode active material was applied to the surface of the band-shaped negative electrode foil 22A to form a covered part for the negative electrode 22. In this case, the active material non-covered parts 21C and 22C without the positive electrode active material or negative electrode active material applied were prepared at one end of the positive electrode 21 in the widthwise direction and one end of the negative electrode 22 in the widthwise direction. Notches were formed in parts of the active material non-covered parts 21C and 22C, corresponding to the winding starts at the time of winding. The positive electrode 21 and the negative electrode 22 were subjected to steps such as drying. Then, the electrodes were stacked with the separator 23 interposed therebetween such that the active material non-covered part 21C of the positive electrode and the active material non-covered part 22C of the negative electrode were oriented in opposite directions, and spirally wound so as to form the through hole 26 in the central axis and dispose the formed notches near the central axis, thereby preparing the electrode wound body 20 as shown in FIG. 4A.

Next, as shown in FIG. 4B, an end of a thin flat plate (for example, 0.5 mm in thickness) or the like was pressed perpendicularly to the end surfaces 41 and 42 to locally bend the end surfaces 41 and 42 and then prepare the grooves 43. In accordance with this method, the groove 43 extending toward the central axis was prepared in radiation directions from the through hole 26. The number of the grooves 43 and the arrangement, shown in FIG. 4B, is considered by way of example only. Then, as shown in FIG. 4C, the same pressure was applied simultaneously from both electrode sides in a direction substantially perpendicular to the end surfaces 41 and 42 to bend the active material non-covered part 21C of the positive electrode and the active material non-covered part 22C of the negative electrode, and then form the end surfaces 41 and 42 so as to have flat surfaces. In this case, the load was applied with the plate surface of the flat plate or the like such that the active material non-covered parts at the end surfaces 41 and 42 overlapped and then bent toward the through hole 26. Thereafter, the fan-shaped part 31 of positive electrode current-collecting plate 24 was subjected to laser welding to the end surface 41, and the fan-shaped part 33 of the negative electrode current-collecting plate 25 was subjected to laser welding to the end surface 42.

Thereafter, as shown in FIG. 4D, the band-shaped parts 32 and 34 of the current-collecting plates 24, 25 were bent, and the insulating plates 12 and 13 (or insulating tapes) were attached to the positive electrode current-collecting plate 24 and the negative electrode current-collecting plate 25, the electrode wound body 20 assembled as mentioned above was inserted into the battery can 11 shown in FIG. 4E, and the bottom of the battery can 11 was subjected to welding. After injecting an electrolytic solution into the can llbattery, sealing was performed with the gasket 15 and the battery cover 14 as shown in FIG. 4F.

### EXAMPLES

The present application will be specifically described with reference to examples of comparing the fraction defective in welding and the resistance value with the use of the lithium ion battery 1 prepared in the manner mentioned above. It is to be noted that the present application is not to be considered limited to the examples described below.

In all of the following examples and comparative examples, the battery size was 21700, the width of the active material covered part 21B of the positive electrode was adjusted to 59 mm, the width of the active material covered part 22B of the negative electrode was adjusted to 62 mm, and the width of the separator 23 was adjusted to 64 mm. The separator 23 was stacked so as to cover the overall ranges of the active material covered part 21B of the positive electrode and of the active material covered part 22B of the negative electrode, and the width of the active material non-covered part of the positive electrode was adjusted to 7 mm, and the width of the active material non-covered part of the negative electrode was adjusted to 4 mm. According to Examples 1 to 8 and Comparative Example 1, the number of grooves 43 was 8, and the grooves were arranged in a substantially equiangular manner. According to Comparative Example 2 and Comparative Example 3, no groove 43 was formed. The materials of the positive foil and of the current collector exposed part of the positive electrode were Al, and the materials of the negative foil and of the current collector exposed part of the negative electrode were a Cu alloy.

The number of windings k of the positive electrode 21 in the electrode wound body 20 was adjusted to 40, and the number of windings m of the negative electrode 22 in the electrode wound body 20 was adjusted to 41. Hereinafter, a site where the end surface 41 and positive electrode current-collecting plate 24 of the positive electrode are welded is referred to as a positive-electrode welded point 51, and a site where the end surface 42 and negative electrode current-collecting plate 25 of the negative electrode are welded is referred to as a negative-electrode welded point 52. Furthermore, a group of positive-electrode welded points 51 is referred to as a positive-electrode welded point group, and a group of negative-electrode welded points 52 is referred to as a negative electrode welded point group. At the ends 41 and 42 (flat surfaces), welded points 51 or 52 (welding point group) were formed at the position of the positive electrode current-collecting plate 24 or the position of the negative electrode current-collecting plate 25 corresponding to the position where no groove 43 was formed. When the shape of the welded point group is concentric or spiral, the number of revolutions of the welded point group around the current-collecting plate 24 or 25 was referred to as the number of turns l of the positive-electrode welded points or the number of turns n of the negative-electrode welded points.

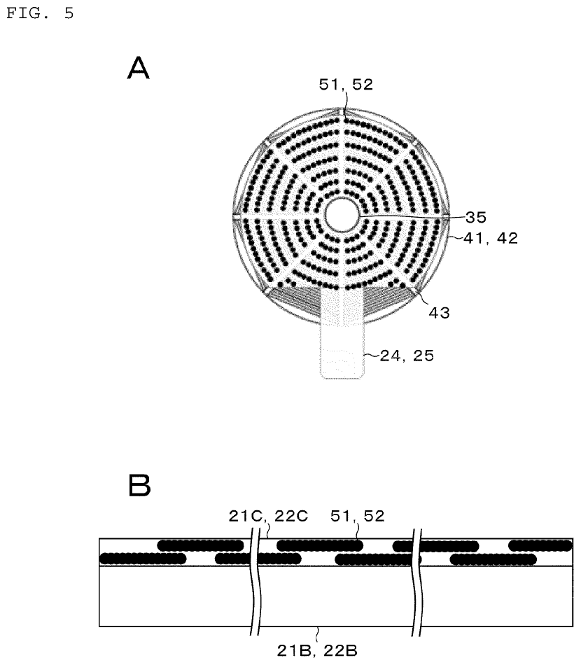

In all of the examples and comparative examples excluding Comparative Example 1, the number of welded points was adjusted to about 250 points for each positive electrode current-collecting plate 24 or each negative electrode current-collecting plate 25. FIGS. 5A to 9A are diagrams illustrating the current collecting-plate 24 or 25 joined by welding from above the end surface 41 or 42 as viewed from the Z-axis direction, where black circles indicate welded spots. FIGS. 5B to 9B are schematic diagrams corresponding to FIGS. 5A to 9A before winding the positive electrode 21 or negative electrode 22, which are diagrams schematically illustrating which positions of the positive electrode 21 or the negative electrode 22 before winding correspond to the welded points 51 or 52 od the end surface 41 or 42 of the electrode wound body 20. The black circles or regions filled in black in FIGS. 5B to 9B indicate welded points 51 or 52 or continuous welded points 51 or 52. The left sides in FIGS. 5B to 9B refer to winding start sides, whereas the right sides therein refer to winding end sides.

### Example 1

The shape of the welded point group of the positive electrode was made concentric as shown in FIG. 5A, and the number of turns l of the positive-electrode welded points was adjusted to 7, thereby providing k/l of 5.7. The shape of the welded point group of the negative electrode was made concentric as shown in FIG. 5A, and the number of turns n of the negative-electrode welded points was adjusted to 7, thereby providing m/n of 5.9.

### Example 2

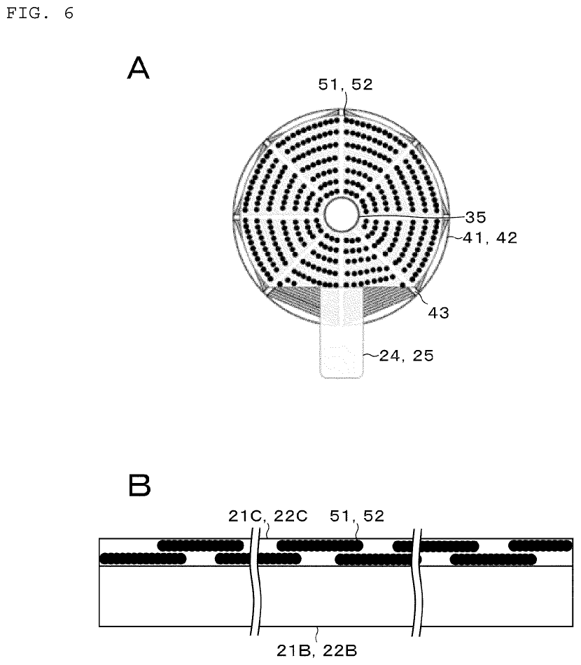

The shape of the welded point group of the positive electrode was made spiral as shown in FIG. 6A, and the number of turns l of the positive-electrode welded points was adjusted to 7, thereby providing k/l of 5.7. The shape of the welded point group of the negative electrode was made spiral as shown in FIG. 6A, and the number of turns n of the negative-electrode welded points was adjusted to 7, thereby providing m/n of 5.9.

### Example 3

The shape of the welded point group of the positive electrode was made concentric as shown in FIG. 5A, and the number of turns l of the positive-electrode welded points was adjusted to 6, thereby providing k/l of 6.7. The shape of the welded point group of the negative electrode was made concentric as shown in FIG. 5A, and the number of turns n of the negative-electrode welded points was adjusted to 6, thereby providing m/n of 6.8.

### Example 4

The shape of the welded point group of the positive electrode was made spiral as shown in FIG. 6A, and the number of turns l of the positive-electrode welded points was adjusted to 5, thereby providing k/l of 8.0. The shape of the welded point group of the negative electrode was made spiral as shown in FIG. 6A, and the number of turns n of the negative-electrode welded points was adjusted to 5, thereby providing m/n of 8.2.

### Example 5

The shape of the welded point group of the positive electrode was made concentric as shown in FIG. 5A, and the number of turns l of the positive-electrode welded points was adjusted to 10, thereby providing k/l of 4.0. The shape of the welded point group of the negative electrode was made concentric as shown in FIG. 5A, and the number of turns n of the negative-electrode welded points was adjusted to 10, thereby providing m/n of 4.1.

### Example 6

The shape of the welded point group of the positive electrode was made spiral as shown in FIG. 6A, and the number of turns l of the positive-electrode welded points was adjusted to 10, thereby providing k/l of 4.0. The shape of the welded point group of the negative electrode was made spiral as shown in FIG. 6A, and the number of turns n of the negative-electrode welded points was adjusted to 10, thereby providing m/n of 4.1.

### Example 7

The shape of the welded point group of the positive electrode was made concentric as shown in FIG. 5A, and the number of turns l of the positive-electrode welded points was adjusted to 11, thereby providing k/l of 3.6. The shape of the welded point group of the negative electrode was made concentric as shown in FIG. 5A, and the number of turns n of the negative-electrode welded points was adjusted to 11, thereby providing m/n of 3.7.

### Example 8

The shape of the welded point group of the positive electrode was made spiral as shown in FIG. 6A, and the number of turns l of the positive-electrode welded points was adjusted to 11, thereby providing k/l of 3.6. The shape of the welded point group of the negative electrode was made spiral as shown in FIG. 6A, and the number of turns n of the negative-electrode welded points was adjusted to 11, thereby providing m/n of 3.7.

### Comparative Example 1

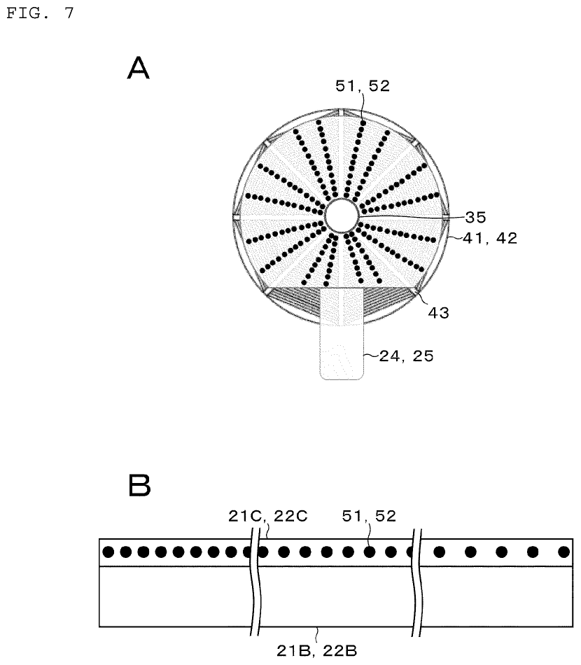

The shape of the welded point group of the positive electrode was made radial as shown in FIG. 7A, whereas the shape of the welded point group of the negative electrode was made radial as shown in FIG. 7A.

### Comparative Example 2

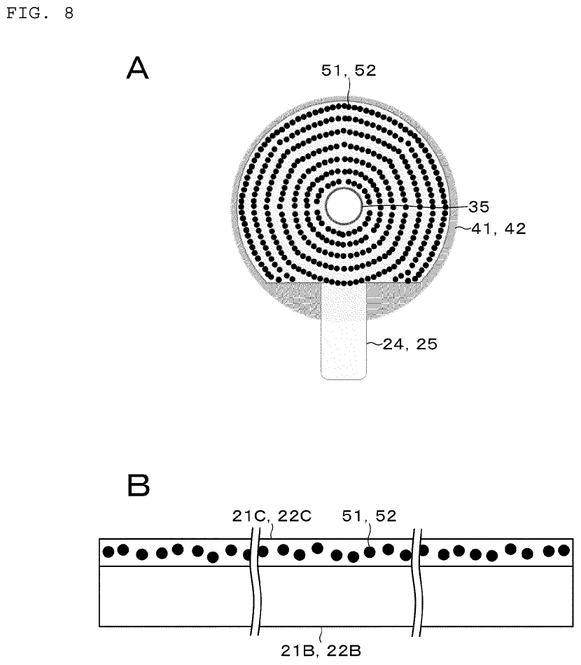

The shape of the welded point group of the positive electrode was made concentric as shown in FIG. 8A, and the number of turns l of the positive-electrode welded points was adjusted to 7, thereby providing k/l of 5.7. The shape of the welded point group of the negative electrode was made concentric as shown in FIG. 8A, and the number of turns n of the negative-electrode welded points was adjusted to 7, thereby providing m/n of 5.9.

### Comparative Example 3

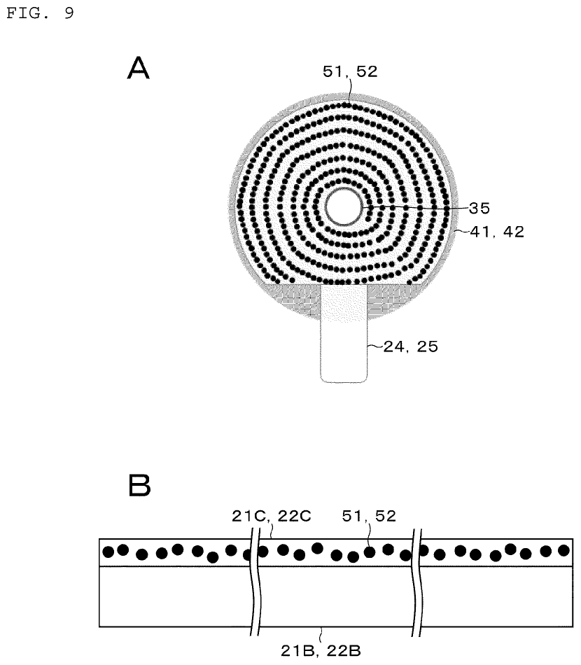

The shape of the welded point group of the positive electrode was made spiral as shown in FIG. 9A, and the number of turns l of the positive-electrode welded points was adjusted to 7, thereby providing k/l of 5.7. The shape of the welded point group of the negative electrode was made spiral as shown in FIG. 9A, and the number of turns n of the negative-electrode welded points was adjusted to 7, thereby providing m/n of 5.9.

For the examples mentioned above, one battery 1 was prepared for each example, and subjected to evaluations. The end surface 41 and positive electrode current-collecting plate 24 of the positive electrode were subjected to laser welding, the number of points at which the generation of a welding defect such as perforation or sputtering was visually recognized in the current-collecting plate 24 was counted after the welding, and the proportion thereof was defined as a fraction defective in welding for the positive electrode. For the negative electrode side, the number of points was also similarly counted, and regarded as a fraction defective in welding for the negative electrode. Furthermore, the internal resistance (direct-current resistance value DCR and alternate-current resistance value ACR) of the battery 1 was measured. The direct-current resistance value DCR is obtained by calculating the slope of the voltage in the case of increasing the discharge current from 0 (A) to 100 (A) in 5 seconds. The alternate-current resistance value ACR is obtained by measuring at 1 kHz. The results are shown in Table 1.

TABLE 1

| | | Shape of | | Number of | | | Shape of | | Number of | |
|---|---|---|---|---|---|---|---|---|---|---|
| | Groove | Welded | Number of | Turns 1 | | Groove at | Welded | Number of | Turns n | |
| | at End of | Point | Windings | of Welded | | End of | Point | Windings | of Welded | |
| | Positive | Group of | k of | Point of | | Negative | Group of | m of | Point of | |
| | Electrode | Positive | Positive | Positive | | Electrode | Negative | Negative | Negative | |
| | Side | Electrode | Electrode | Electrode | k/l | Side | Electrode | Electrode | Electrode | m/n |
| Example 1 | Yes | Concentric | 40 | 7 | 5.7 | Yes | Concentric | 41 | 7 | 5.9 |
| Example 2 | Yes | Spiral | 40 | 7 | 5.7 | Yes | Spiral | 41 | 7 | 5.9 |
| Example 3 | Yes | Concentric | 40 | 6 | 6.7 | Yes | Concentric | 41 | 6 | 6 . 8 |
| Example 4 | Yes | Spiral | 40 | 5 | 8.0 | Yes | Spiral | 41 | 5 | 8.2 |
| Example 5 | Yes | Concentric | 40 | 10 | 4.0 | Yes | Concentric | 41 | 10 | 4.1 |
| Example 6 | Yes | Spiral | 40 | 10 | 4.0 | Yes | Spiral | 41 | 10 | 4.1 |
| Example 7 | Yes | Concentric | 40 | 11 | 3.6 | Yes | Concentric | 41 | 11 | 3.7 |
| Example 8 | Yes | Spiral | 40 | 11 | 3.6 | Yes | Spiral | 41 | 11 | 3.7 |
| Comparative | Yes | Radial | 40 | — | — | Yes | Radial | 41 | —— | |
| Example 1 | | | | | | | | | | |
| Comparative | No | Concentric | 40 | 7 | 5.7 | No | Concentric | 41 | 7 | 5.9 |
| Example 2 | | | | | | | | | | |
| Comparative | No | Spiral | 40 | 7 | 5.7 | No | Spiral | 41 | 7 | 5.9 |
| Example 3 | | | | | | | | | | |
| | | | | | | | Fraction | Fraction | | |
| | | | | | | | Defective | Defective | | |
| | | | | | | | in | in | | |
| | | | | | | | Welding | Welding | | |
| | | | | | | | for | for | | |
| | | | | | | | Positive | Negative | Resistance | Resistance |
| | | | | | | | Electrode | Electrode | Value ACR | Value DCR |
| | | | | | | | (%) | (%) | (mQ) | (mQ) |
| | | | | | | Example 1 | 0.8 | 1.8 | 3.8 | 7.7 |
| | | | | | | Example 2 | 0.8 | 1.8 | 3.8 | 7.7 |
| | | | | | | Example 3 | 0.7 | 1.6 | 4.0 | 8.1 |
| | | | | | | Example 4 | 0.7 | 1.6 | 4.1 | 8.2 |
| | | | | | | Example 5 | 0.8 | 1.8 | 3.8 | 7.7 |
| | | | | | | Example 6 | 0.8 | 1.8 | 3.8 | 7.7 |
| | | | | | | Example 7 | 1.0 | 1.9 | 3.8 | 7.7 |
| | | | | | | Example 8 | 1.0 | 2.0 | 3.8 | 7.7 |
| | | | | | | Comparative | 0.8 | 1.8 | 4.2 | 8.7 |
| | | | | | | Example 1 | | | | |
| | | | | | | Comparative | 3.6 | 7.2 | 5.6 | 9.6 |
| | | | | | | Example 2 | | | | |
| | | | | | | Comparative | 4.1 | 7.5 | 5.6 | 9.6 |
| | | | | | | Example 3 | | | | |

In Examples 1 to 8, the fraction defective in welding for the positive electrode was 1.0% or lower, the fraction defective in welding for the negative electrode was 2.0% or lower, the resistance value ACR was 4.1 mΩ or lower, and the resistance value DCR was 8.2 mΩ or lower, whereas in Comparative Examples 1 to 3, these values were higher than the upper limit values of Examples 1 to 8. In Examples 1 to 8, as shown in FIGS. 5B and 6B, the welded points 51 and 52 were present in almost the whole areas in the active material non-covered part 21C of the positive electrode and the active material non-covered part 22C of the negative electrode, thus allowing uniform welding, whereas in Comparative Example 1, as shown in FIG. 7B, the intervals between the welded points 51 and 52 were gradually increased toward the winding end side, thus unevenly arranging the welded points 51 and 52, and in Comparative Examples 2 and 3, as shown in FIGS. 8B and 9B, the intervals between the welded points 51 and 52 were almost random, thus unevenly arranging the welded points 51 and 52. From the foregoing, in the case where the end surfaces 41 and 42 have the grooves 43, it can be determined that when the shape of the welded point group is concentric or spiral, the internal resistance of the battery has a low value, thus allowing the current-collecting plates 24 and 25 and the end surfaces 41 and 42 to be welded stably. In addition, from Table 1, Examples 1 to 8 have 3.6≤k/l≤8.0 and 3.7≤m/n≤8.2, and thus in this case, it can be determined that the internal resistance has a low value, thus allowing the current-collecting plates and the end surfaces to be welded stably.

While the present application has been described above, the contents of the present application are not to be considered limited to the described above, and it is possible to make various modifications.

For example, although the number of grooves 43 was 8 in the examples and the comparative examples, other numbers may be employed. The battery size was 21700, but may be 18650 or any other size.

The positive electrode current-collecting plate 24 and the negative electrode current-collecting plate 25 respectively include the fan-shaped parts 31 and 33 in the shape a fan, which may have other shapes.

The present application can also be applied to other batteries other than lithium ion batteries and batteries in a shape other than a cylindrical shape (for example, a laminate-type battery, a square-type battery, a coin-type battery, or a button-type battery) without departing from the spirit of the present application. In this case, the shape of “the end surface of the electrode wound body” may be not only a cylindrical shape, but also an elliptical shape, a flattened shape, and the like.

FIG. 4 is a block diagram illustrating a circuit configuration example in the case of applying a secondary battery according to an embodiment to a battery pack 300. The battery pack 300 includes an assembled battery 301, a switch unit 304 including a charge control switch 302a and a discharge control switch 303a, a current detection resistor 307, a temperature detection element 308, and a control unit 310. The control unit 310 controls each device, and is further capable of performing charge/discharge control at the time of abnormal heat generation, and calculating and correcting the remaining capacity of the battery pack 300. The positive electrode terminal 321 and negative electrode terminal 322 of the battery pack 300 are connected to a charger or an electronic device for charge/discharge.

The assembled battery 301 has a plurality of secondary batteries 301a connected in series and/or in parallel. FIG. 4 shows therein, as an example, a case where six secondary batteries 301a are connected so as to arrange two batteries in parallel and three batteries in series (2P3S).

A temperature detection unit 318 is connected to the temperature detection element 308 (for example, a thermistor), for measuring the temperature of the assembled battery 301 or the battery pack 300, and then supplying the measured temperature to the control unit 310. The voltage detection unit 311 measures the voltages of the assembled battery 301 and of the secondary batteries 301a constituting the assembled battery, performs A/D conversion of the measured voltages, and supplies the converted voltages to the control unit 310. A current measurement unit 313 measures a current with the use of the current detection resistor 307, and supplies the measured current to the control unit 310.

The switch control unit 314 controls the charge control switch 302a and discharge control switch 303a of the switch unit 304, based on the voltages and current input from the voltage detection unit 311 and the current measurement unit 313. The switch control unit 314 transmits an OFF control signal to the switch unit 304 when the secondary battery 301a reaches a voltage equal to or higher than an overcharge detection voltage (for example, 4.20 V±0.05 V) or equal to or lower than an overdischarge detection voltage (2.4 V±0.1 V), thereby preventing overcharge or overdischarge.

After the charge control switch 302a or the discharge control switch 303a is turned off, charge or discharge is allowed only through the diode 302b or the diode 303b. For the charge/discharge switch, a semiconductor switch such as a MOSFET can be used. It is to be noted that the switch unit 304 is provided on the positive side in FIG. 4, but may be provided on the negative side.

The memory 317 includes a RAM and a ROM, and stores and rewrites the values of the battery characteristics calculated by the control unit 310, the full charge capacity, the remaining capacity, and the like.

The above-described secondary battery according to an embodiment can be mounted on and used to supply electric power to electronic devices and electrical transportation devices, and devices such as electric storage devices.

Examples of the electronic devices include lap-top computers, smartphones, tablet terminals, PDAs (personal digital assistants), mobile phones, wearable terminals, digital still cameras, electronic books, music players, game machines, hearing aids, electric tools, televisions, lighting devices, toys, medical devices, and robots. In addition, the electric transportation device, electric storage devices, electric tool, and electric unmanned aircraft as described later can also be included in the electronic devices in a broad sense.

Examples of the electrical transportation devices include electric automobiles (including hybrid automobiles), electric motorbikes, electric assist bicycles, electric buses, electric carts, automatic guided vehicles (AGVs) and railway vehicles. In addition, the examples also include electric passenger aircraft and electric unmanned aircraft for transportation. The secondary battery according to an embodiment is used not only as a driving power supply for the examples, but also as an auxiliary power supply, an energy regeneration power supply, and the like.

Examples of the electric storage devices include electric storage modules for commercial use or home use, and power supplies for power storage for architectural structures such as houses, buildings, and offices, or power generation facilities.

An example of an electric driver as an electric tool to an embodiment will be schematically described with reference to FIG. 5. An electric driver 431 is provided with a motor 433 that transmits rotative power to a shaft 434 and a trigger switch 432 operated by a user. A battery pack 430 according to an embodiment and a motor control unit 435 are housed in a lower housing of a handle of the electric driver 431. The battery pack 430 is built in the electric driver, or detachable from the electric driver 431.

The battery pack 430 and the motor control unit 435 each may include a microcomputer (not shown), such that charge/discharge information of the battery pack 430 can be communicated with each other. The motor control unit 435 can control the operation of the motor 433, and cut off the power supply to the motor 433 at the time of abnormality such as overdischarge.

FIG. 6 schematically illustrates a configuration example of a hybrid vehicle (HV) that employs a series hybrid system, as an example of an electric storage system for an electric vehicle according to an embodiment. The series hybrid system is intended for a vehicle that runs on an electric power-driving force conversion device, with the use of electric power generated by a generator powered by an engine, or the electric power stored once in the battery.

The hybrid vehicle 600 carries an engine 601, a generator 602, the electric power-driving force conversion device 603 (direct-current motor or alternate-current motor, hereinafter referred to simply as a “motor 603”), a driving wheel 604a, a driving wheel 604b, a wheel 605a, a wheel 605b, a battery 608, a vehicle control device 609, various sensors 610, and a charging port 611. As the battery 608, the battery pack 300 or an electric storage module mounted with a plurality of secondary batteries according to an embodiment can be applied.

The motor 603 is operated by the electric power of the battery 608, and the torque of the motor 603 is transmitted to the driving wheels 604a and 604b. The torque produced by the engine 601 makes it possible to reserve, in the battery 608, the electric power generated by the generator 602. The various sensors 610 control the engine rotation speed via the vehicle control device 609, and control the position of a throttle valve, not shown.

When the hybrid vehicle 600 is decelerated by a braking mechanism, not shown, the resistance force during the deceleration is applied as torque to the motor 603, and the regenerative electric power generated by the torque is reserved in the battery 608. The battery 608 is connected to an external power supply through the charging port 611 of the hybrid vehicle 600, thereby making charge possible. Such an HV vehicle is referred to as a plug-in hybrid vehicle (PHV or PHEV).

It is to be noted that the secondary battery according to an embodiment can also be applied to a downsized primary battery, and then used as a power supply for a pneumatic sensor system (TPMS: Tire Pressure Monitoring System) built in the wheels 604 and 605.

Although the series hybrid vehicle has been described above as an example, the present application can be also applied to a parallel system in which an engine and a motor are used in combination or a hybrid vehicle in which a series system and a parallel system are combined. Furthermore, the present application can be also applied to electric vehicles (EVs or BEVs) that run on driving by only a driving motor without using any engine, and fuel cell vehicles (FCVs).

### DESCRIPTION OF REFERENCE SYMBOLS

1: Lithium ion battery

12: Insulating plate

21: Positive electrode

21A: Positive electrode foil

21B: Positive electrode active material layer

21C: Active material non-covered part of positive electrode

22: Negative electrode

22A: Negative electrode foil

22B: Negative electrode active material layer

22C: Active material non-covered part of negative electrode

23: Separator

24: Positive electrode current-collecting plate

25: Negative electrode current-collecting plate

26: Through hole

27, 28: Outer edge

41, 42: End surface

43: Groove

51: Welded point of positive electrode

52: Welded point of negative electrode

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body that has a band-shaped positive electrode and a band-shaped negative electrode stacked with a separator interposed therebetween and has a wound structure;
a positive electrode current-collecting plate;
a negative electrode current-collecting plate; and
a battery can housing the electrode wound body, the positive electrode current-collecting plate and the negative electrode current-collecting plate,
wherein the positive electrode includes a covered part covered with a positive electrode active material layer and a positive electrode active material non-covered part on a band-shaped positive electrode foil,
the negative electrode includes a covered part covered with a negative electrode active material layer and a negative electrode active material non-covered part on a band-shaped negative electrode foil,
the positive electrode active material non-covered part is joined to the positive electrode current-collecting plate at one end of the electrode wound body,
the negative electrode active material non-covered part is joined to the negative electrode current-collecting plate at the other end of the electrode wound body,
any one or both of the positive electrode active material non-covered part and the negative electrode active material non-covered part have a flat surface formed by bending toward a central axis of the wound structure and overlapping each other, and
a groove formed in the flat surface,
a position of the positive electrode current-collecting plate or a position of the negative electrode current-collecting plate corresponding to a position of the flat surface without any groove has a welded point group, and
the welded point group has a concentric or spiral shape.

2. The secondary battery according to claim 1, wherein the secondary battery meets 3.6≤k/l≤8.0, where k is a number of windings of the positive electrode, and l is a number of turns of the welded point group at the positive electrode current-collecting plate.

3. The secondary battery according to claim 2, wherein the secondary battery meets 3.7≤m/n≤8.2, where m is a number of windings of the negative electrode, and n is a number of turns of the welded point group at the negative electrode current-collecting plate.

4. An electronic device comprising the secondary battery according to claim 1.

5. An electric tool comprising the secondary battery according to claim 1.

6. The secondary battery according to claim 1, wherein the secondary battery meets 3.7≤m/n≤8.2, where m is a number of windings of the negative electrode, and n is a number of turns of the welded point group at the negative electrode current-collecting plate.
